(19) United States
(12) Patent Application Publication
(10) Pub. No.: US 2021/0250572 A1
(43) Pub. Date: Aug. 12, 2021

(54) CONTEXTUAL LIGHTFIELD DISPLAY SYSTEM, MULTIVIEW DISPLAY, AND METHOD

(71) Applicant: LEIA INC., Menlo Park, CA (US)

(72) Inventor: David A. Fattal, Menlo Park, CA (US)

(21) Appl. No.: 17/239,649

(22) Filed: Apr. 25, 2021

Related U.S. Application Data
(63) Continuation of application No. PCT/US2018/059647, filed on Nov. 7, 2018.
(60) Provisional application No. 62/754,555, filed on Nov. 1, 2018.

(51) Int. Cl. H04N 13/398; H04N 13/351; H04N 13/359; H04N 13/32

(52) U.S. Cl. CPC H04N 13/398; H04N 13/32; H04N 13/359; H04N 13/351

(57) ABSTRACT

A contextual lightfield display system and contextual lightfield multiview display provide a plurality of lightfield display modes based on a display context. The contextual lightfield display system includes a multiview display configured to provide the lightfield display modes and a lightfield mode selector configured to determine the display context and to select a lightfield display mode using the determined display context. The contextual lightfield multiview display includes multibeam elements configured to provide directional light beams and light valves configured to modulate the directional light beams as a multiview image. Selectable lightfield display modes may include a stereoscopic three-dimensional (3D) display mode, a unidirectional parallax display mode, a full parallax display mode, and a two-dimensional (2D) display mode.

### CROSS-REFERENCE TO RELATED APPLICATIONS

This application is a continuation application of and claims the benefit of priority to International application No. PCT/US2018/059647, filed Nov. 7, 2018, which claims priority to U.S. Provisional Patent Application Ser. No. 62/754,555, filed Nov. 1, 2018, the entirety of both of which is incorporated by reference herein.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of angular components of a light beam having a particular principal angular direction corresponding to a view direction of a multiview display in an example, according to an embodiment consistent with the principles described herein.

FIG. 2 illustrates a cross sectional view of a diffraction grating in an example, according to an embodiment consistent with the principles described herein.

FIG. 3A illustrates a block diagram of a contextual lightfield display system in an example, according to an embodiment consistent with the principles described herein.

FIG. 3B illustrates a perspective view of a contextual lightfield display system in an example, according to an embodiment consistent with the principles described herein.

FIG. 3C illustrates a plan view of the contextual lightfield display system of FIG. 3B in another example, according to an embodiment consistent with the principles described herein.

FIG. 4A illustrates a graphical representation of an arrangement of views of a multiview display corresponding to a stereoscopic display mode in an example, according to an embodiment consistent with the principles described herein.

FIG. 4B illustrates a graphical representation of an arrangement of views of a multiview display corresponding to a unidirectional parallax display mode in an example, according to an embodiment consistent with the principles described herein.

FIG. 4C illustrates a graphical representation of an arrangement of views of a multiview display corresponding to a unidirectional parallax display mode in another example, according to an embodiment consistent with the principles described herein.

FIG. 4D illustrates a graphical representation of an arrangement of views of a multiview display corresponding to a full parallax display mode in an example, according to an embodiment consistent with the principles described herein.

FIG. 5A illustrates a cross sectional view of a multiview display in an example, according to an embodiment consistent with the principles described herein.

FIG. 5B illustrates a plan view of a multiview display in an example, according to an embodiment consistent with the principles described herein.

FIG. 5C illustrates a perspective view of a multiview display in an example, according to an embodiment consistent with the principles described herein.

FIG. 6A illustrates a cross sectional view of a portion of a multiview display including a multibeam element in an example, according to an embodiment consistent with the principles described herein.

FIG. 6B illustrates a cross sectional view of a portion of a multiview display including a multibeam element in an example, according to another embodiment consistent with the principles described herein.

FIG. 7A illustrates a cross sectional view of a portion of a multiview display including a multibeam element in an example, according to another embodiment consistent with the principles described herein.

FIG. 7B illustrates a cross sectional view of a portion of a multiview display including a multibeam element in an example, according to another embodiment consistent with the principles described herein.

FIG. 8 illustrates a cross sectional view of a portion of a multiview display including a multibeam element in an example, according to another embodiment consistent with the principles described herein.

FIG. 9 illustrates a cross-sectional view of a multiview display in an example, according to another embodiment consistent with the principles described herein.

FIG. 10 illustrates a block diagram of a contextual lightfield multiview display in an example, according to an embodiment of the principles described herein.

FIG. 11 illustrates a flow chart of a method of contextual lightfield display system operation in an example, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a system and a display configured to create a contextual lightfield display mode for a user. In particular, a contextual lightfield display system may include a multiview display that is configured to display a multiview image comprising multiview or three-dimensional (3D) content according to lightfield display mode. The lightfield display mode may be selected using a lightfield mode selector configured to determine a display context and to select the lightfield display mode from among a plurality of lightfield display modes based on the determined display context. According to various embodiments, the lightfield display mode may comprise a mode-specific arrangement of different views of the multiview image. For example, the selected lightfield display mode may include, but is not limited to, a stereoscopic three-dimensional (3D) display mode, a unidirectional parallax display mode, a full parallax display mode, and a 2D display mode.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A liquid crystal display (LCD) found in may smart phones and computer monitors are examples of 2D displays. In contrast herein, a ‘multiview display’ is defined as an electronic display or display system configured to provide different views of a multiview image in or from different view directions. In particular, the different views may represent different perspective views of a scene or object of the multiview image. In some instances, a multiview display may also be referred to as a three-dimensional (3D) display, e.g., when simultaneously viewing two different views of the multiview image provides a perception of viewing a three dimensional image.

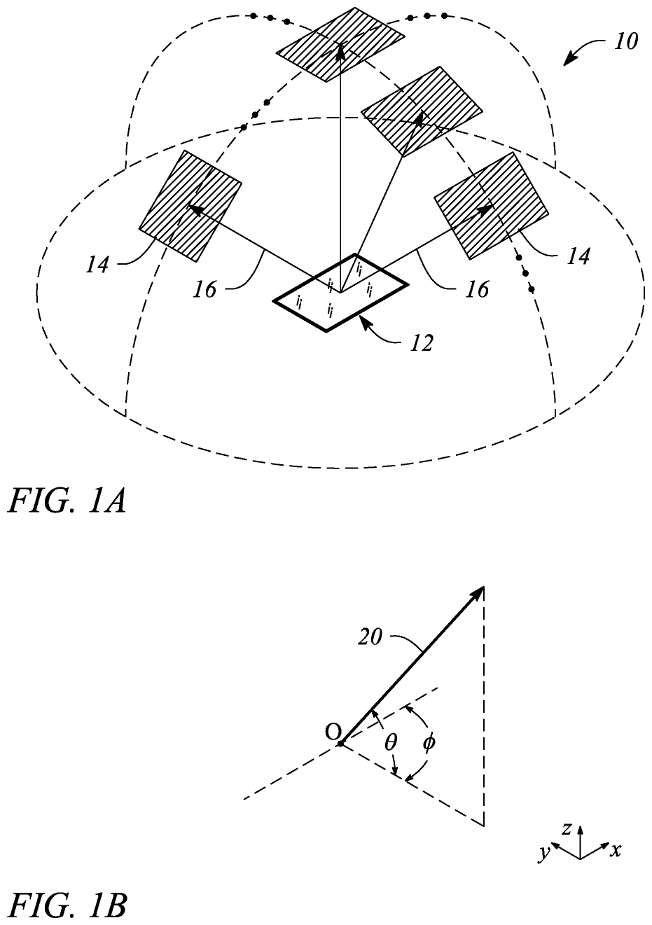

FIG. 1A illustrates a perspective view of a multiview display 10 in an example, according to an embodiment consistent with the principles described herein. As illustrated in FIG. 1A, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions; the different views 14 are illustrated as polygonal boxes at the termination of the arrows (i.e., depicting the view directions 16); and only four views 14 and four view directions 16 are illustrated, all by way of example and not limitation. Note that while the different views 14 are illustrated in FIG. 1A as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction corresponding to a view direction of a multiview display generally has a principal angular direction given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane). FIG. 1B illustrates a graphical representation of the angular components {θ, ϕ} of a light beam 20 having a particular principal angular direction corresponding to a view direction (e.g., view direction 16 in FIG. 1A) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin O.

Further herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set or group of sub-pixels (such as light valves) representing ‘view’ pixels in each view of a plurality of different views of a multiview display. In particular, a multiview pixel may have an individual sub-pixel corresponding to or representing a view pixel in each of the different views of the multiview image. Moreover, the sub-pixels of the multiview pixel are so-called ‘directional pixels’ in that each of the sub-pixels is associated with a predetermined view direction of a corresponding one of the different views, by definition herein. Further, according to various examples and embodiments, the different view pixels represented by the sub-pixels of a multiview pixel may have equivalent or at least substantially similar locations or coordinates in each of the different views. For example, a first multiview pixel may have individual sub-pixels corresponding to view pixels located at {x₁, y₁} in each of the different views of a multiview image, while a second multiview pixel may have individual sub-pixels corresponding to view pixels located at {x₂, y₂} in each of the different views, and so on.

Herein, a ‘light guide’ is defined as a structure that guides light within the structure using total internal reflection. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to insure that total internal reflection is maintained within the plate light guide to guide light.

Herein, a ‘diffraction grating’ is broadly defined as a plurality of features (i.e., diffractive features) arranged to provide diffraction of light incident on the diffraction grating. In some examples, the plurality of features may be arranged in a periodic manner or a quasi-periodic manner. In other examples, the diffraction grating may be a mixed-period diffraction grating that includes a plurality of diffraction gratings, each diffraction grating of the plurality having a different periodic arrangement of features. Further, the diffraction grating may include a plurality of features (e.g., a plurality of grooves or ridges in a material surface) arranged in a one-dimensional (1D) array. Alternatively, the diffraction grating may comprise a two-dimensional (2D) array of features or an array of features that are defined in two dimensions. The diffraction grating may be a 2D array of bumps on or holes in a material surface, for example. In some examples, the diffraction grating may be substantially periodic in a first direction or dimension and substantially aperiodic (e.g., constant, random, etc.) in another direction across or along the diffraction grating.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from the light guide.

Further, by definition herein, the features of a diffraction grating are referred to as ‘diffractive features’ and may be one or more of at, in and on a material surface (i.e., a boundary between two materials). The surface may be a surface of a light guide, for example. The diffractive features may include any of a variety of structures that diffract light including, but not limited to, one or more of grooves, ridges, holes and bumps at, in or on the surface. For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a diffractive multibeam element, as described below) may be employed to diffractively scatter or couple light out of a light guide (e.g., a plate light guide) as a light beam. In particular, a diffraction angle θₘ of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, d is a distance or spacing between features of the diffraction grating, θᵢ is an angle of incidence of light on the diffraction grating. For simplicity, equation (1) assumes that the diffraction grating is adjacent to a surface of the light guide and a refractive index of a material outside of the light guide is equal to one (i.e., nₒᵤₜ=1). In general, the diffraction order m is given by an integer (i.e., m=±1, ±2, . . . ). A diffraction angle θₘ of a light beam produced by the diffraction grating may be given by equation (1). First-order diffraction or more specifically a first-order diffraction angle θₘ is provided when the diffraction order m is equal to one (i.e., m=1).

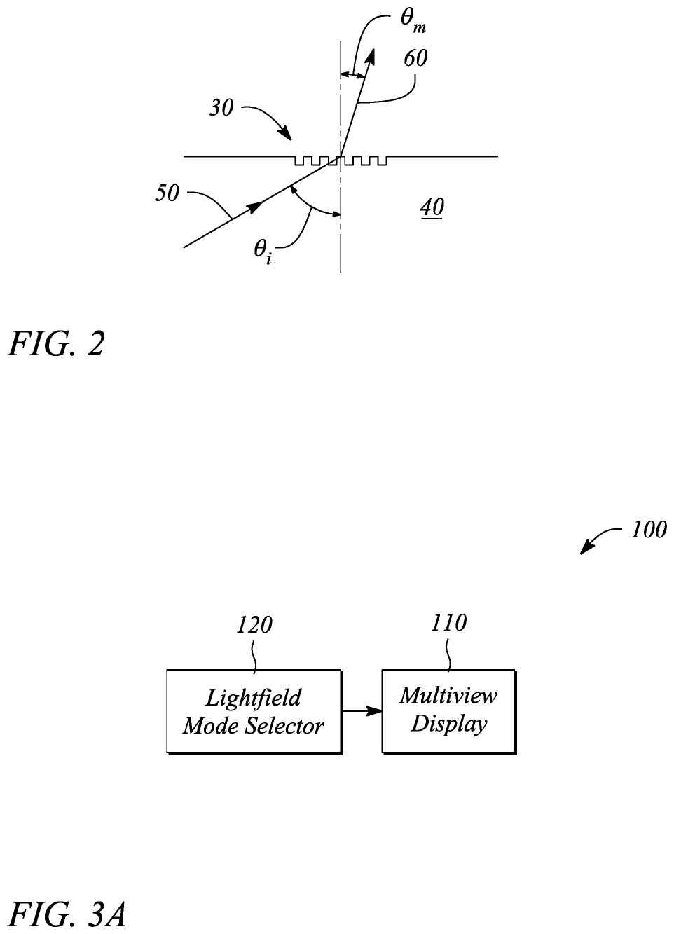

FIG. 2 illustrates a cross sectional view of a diffraction grating 30 in an example, according to an embodiment consistent with the principles described herein. For example, the diffraction grating 30 may be located on a surface of a light guide 40. In addition, FIG. 2 illustrates a light beam 50 incident on the diffraction grating 30 at an incident angle θᵢ. The incident light beam 50 is a guided light beam within the light guide 40. Also illustrated in FIG. 2 is a directional light beam 60 diffractively produced and coupled or scattered by the diffraction grating 30 out of the light guide 40 as a result of diffraction of the incident light beam 50. The directional light beam 60 has a diffraction angle θₘ (or ‘principal angular direction’ herein) as given by equation (1). The directional light beam 60 may correspond to a diffraction order ‘m’ of the diffraction grating 30, for example.

Further, the diffractive features may be curved and may also have a predetermined orientation (e.g., a slant or a rotation) relative to a propagation direction of light, according to some embodiments. One or both of the curve of the diffractive features and the orientation of the diffractive features may be configured to control a direction of light scattered out by the diffraction grating, for example. For example, a principal angular direction of the directional light may be a function of an angle of the diffractive feature at a point at which the light is incident on the diffraction grating relative to a propagation direction of the incident light.

By definition herein, a ‘multibeam element’ is a structure or element of a backlight or a display that produces light that includes a plurality of light beams. A ‘diffractive’ multibeam element is a multibeam element that produces the plurality of light beams by or using diffractive coupling, by definition. In particular, in some embodiments, the diffractive multibeam element may be optically coupled to a light guide of a backlight to provide the plurality of light beams by diffractively coupling out a portion of light guided in the light guide. Further, by definition herein, a diffractive multibeam element comprises a plurality of diffraction gratings within a boundary or extent of the multibeam element. The light beams of the plurality of light beams (or ‘light beam plurality’) produced by a multibeam element have different principal angular directions from one another, by definition herein. In particular, by definition, a light beam of the light beam plurality has a predetermined principal angular direction that is different from another light beam of the light beam plurality. According to various embodiments, the spacing or grating pitch of diffractive features in the diffraction gratings of the diffractive multibeam element may be sub-wavelength (i.e., less than a wavelength of the guided light).

While a multibeam element with a plurality of diffraction gratings is used as an illustrative example in the discussion that follows, in some embodiments other components may be used in multibeam element, such as at least one of a micro-reflective element and a micro-refractive element. For example, the micro-reflective element may include a triangular-shaped mirror, a trapezoid-shaped mirror, a pyramid-shaped mirror, a rectangular-shaped mirror, a hemispherical-shaped mirror, a concave mirror and/or a convex mirror. In some embodiments, a micro-refractive element may include a triangular-shaped refractive element, a trapezoid-shaped refractive element, a pyramid-shaped refractive element, a rectangular-shaped refractive element, a hemispherical-shaped refractive element, a concave refractive element and/or a convex refractive element.

According to various embodiments, the light beam plurality may represent a light field or ‘lightfield’. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the lightfield.

According to various embodiments, the different principal angular directions of the various light beams in the light beam plurality are determined by a characteristic including, but not limited to, a size (e.g., one or more of length, width, area, and etc.) of the diffractive multibeam element along with a ‘grating pitch’ or a diffractive feature spacing and an orientation of a diffraction grating within diffractive multibeam element. In some embodiments, the diffractive multibeam element may be considered an ‘extended point light source’, i.e., a plurality of point light sources distributed across an extent of the diffractive multibeam element, by definition herein. Further, a light beam produced by the diffractive multibeam element has a principal angular direction given by angular components {θ, ϕ}, by definition herein, and as described above with respect to FIG. 1B.

Herein a ‘collimator’ is defined as substantially any optical device or apparatus that is configured to collimate light. For example, a collimator may include, but is not limited to, a collimating mirror or reflector, a collimating lens, a diffraction grating, or various combinations thereof. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments. Herein, a ‘collimation factor,’ denoted a, is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein, the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

By definition, ‘broad-angle’ emitted light is defined as light having a cone angle that is greater than a cone angle of the view of a multiview image or multiview display. In particular, in some embodiments, the broad-angle emitted light may have a cone angle that is greater than about twenty degrees (e.g., >±20°). In other embodiments, the broad-angle emitted light cone angle may be greater than about thirty degrees (e.g., >±30°), or greater than about forty degrees (e.g., >±40°), or greater than fifty degrees (e.g., >±50°). For example, the cone angle of the broad-angle emitted light may be greater than or equal to about sixty degrees (e.g., ≥60°).

In some embodiments, the broad-angle emitted light cone angle may be defined to be about the same as a viewing angle of an LCD computer monitor, an LCD tablet, an LCD television, or a similar digital display device meant for broad-angle viewing (e.g., about ±40-65°). In other embodiments, broad-angle emitted light may also be characterized or described as diffuse light, substantially diffuse light, non-directional light (i.e., lacking any specific or defined directionality), or as light having a single or substantially uniform direction.

Further, as used herein, the article ‘a’ is intended to have its ordinary meaning in the patent arts, namely ‘one or more’. For example, ‘an element’ means one or more elements and as such, ‘the element’ means ‘the element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

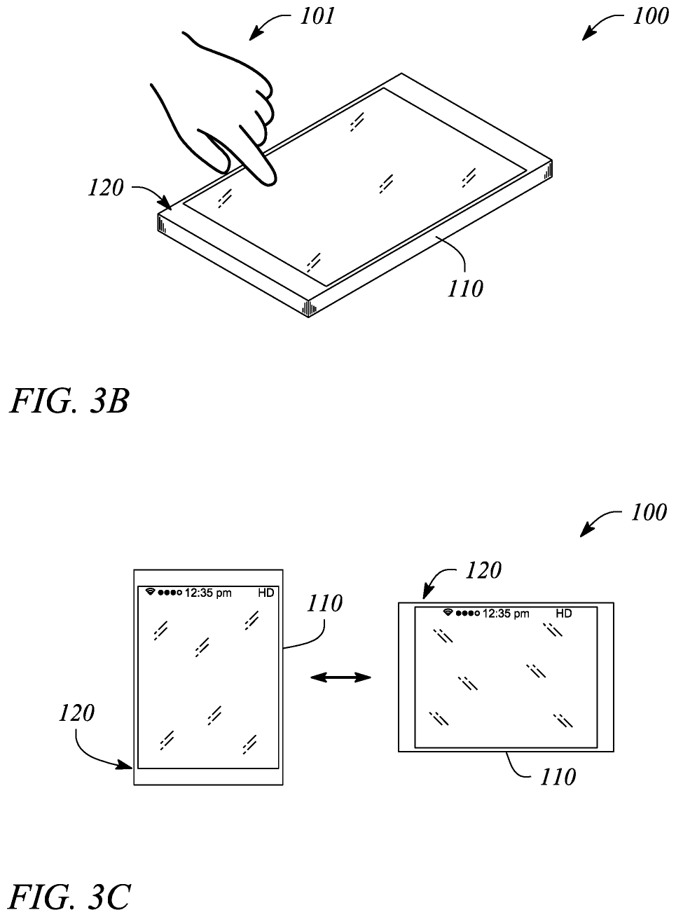

According to embodiments of the principles described herein, a contextual lightfield display system is provided. FIG. 3A illustrates a block diagram of a contextual lightfield display system 100 in an example, according to an embodiment consistent with the principles described herein. FIG. 3B illustrates a perspective view of a contextual lightfield display system 100 in an example, according to an embodiment consistent with the principles described herein. FIG. 3C illustrates a plan view of the contextual lightfield display system 100 of FIG. 3B in another example, according to an embodiment consistent with the principles described herein. In addition, FIG. 3C illustrates the contextual lightfield display system 100 in two different rotational orientations (e.g., rotation about a central axis) relative to a fixed frame or reference. A left side of FIG. 3C may represent the contextual lightfield display system 100 in a horizontal or landscape orientation, while the right side may represent the contextual lightfield display system 100 in a vertical or portrait orientation.

According to various embodiments, the contextual lightfield display system 100 is configured to display multiview content as a multiview image. Further, the contextual lightfield display system 100 facilitates viewing and interacting with the multiview content by a user 101 of the contextual lightfield display system 100 according to or by way of various lightfield display modes of the contextual lightfield display system 100. In particular, while using the contextual lightfield display system 100, the user 101 may be presented with the multiview content with respect to a particular display context. The display context, in turn, may be used to select a lightfield display mode comprising mode-specific arrangements of different views of the multiview image to facilitate viewing and interacting with the multiview content according to the display context. As such, the user 101 may be provided with the multiview content in a more appropriate or perhaps a more compelling manner than may be possible in an absence of the contextual lightfield display system 100, according to various embodiments.

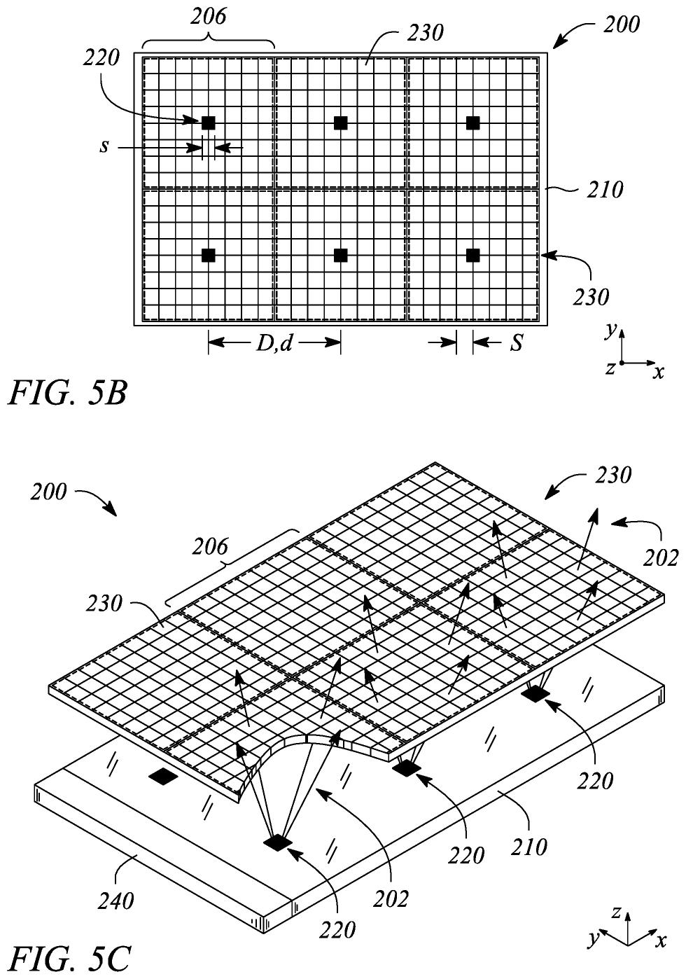

As illustrated in FIG. 3A, the contextual lightfield display system 100 comprises a multiview display 110. The multiview display 110 is configured to provide a plurality of lightfield display modes. Further, the multiview display 110 is configured to display a multiview image according to a selected lightfield display mode of the lightfield display modes. In particular, the displayed multiview image is configured to be viewed by a user 101 of the contextual lightfield display system 100. According to various embodiments, the multiview display 110 may comprise substantially any electronic display capable of displaying the multiview content as the multiview image using light fields or ‘lightfields’. For example, the multiview display 110 may be or include, but is not limited to, various multiview displays of or used in a cellular telephone or a smartphone, a tablet computer, a laptop computer, a notebook computer, a personal or desktop computer, a netbook computer, a media player device, an electronic book device, a smart watch, a wearable computing device, a portable computing device, a consumer electronic device, and a display headset (such as, but not limited to, a virtual-reality headset). For example, FIGS. 3B and 3C may illustrate the contextual lightfield display system 100 as a smartphone or a tablet computer including the multiview display 110 as a display thereof. In some embodiments (e.g., described below with reference to FIG. 5A-5C) the multiview display 110 employ multibeam elements configured to provide a plurality of directional light beams as well as an array of light valves configured to modulate the directional light beams as view pixels of different views of the multiview image.

The contextual lightfield display system 100 illustrated in FIG. 3A further comprises a lightfield mode selector 120. The lightfield mode selector 120 is configured to determine a display context. Further, the lightfield mode selector 120 is configured to select a lightfield display mode from among the plurality of lightfield display modes to be the selected lightfield display mode based on the determined display context. According to various embodiments, a lightfield display mode of the lightfield display mode plurality comprises a mode-specific arrangement of different views of the multiview image or equivalent of the multiview display 110.

According to various embodiments, display context may include any of a variety of aspects that may influence how an image may best be viewed by the user 101 of the contextual lightfield display system 100. In particular, herein ‘display context’ may be defined to at least include any physical configuration of the multiview display 110 or more broadly of the contextual lightfield display system, the content of a displayed image such as, but not limited to, a multiview image, and any combination the physical configuration and image content.

For example, the lightfield mode selector 120 may comprise an orientation sensor configured to detect an orientation of the multiview display, the display context being determined from a detected orientation of the multiview display. The detected orientation may include, but is not limited to, a rotation and a tilt of the multiview display 110 and the orientation sensor may comprise one or both of a gyroscope and an accelerometer, according to some embodiments. In another example, display context may be an orientation of the multiview image itself as provided in the multiview context. For example, the multiview image may have either a portrait orientation or a landscape orientation, the display context being determined from a shape (i.e., portrait or landscape shape) of the multiview image. In yet another example, the multiview content such as either three-dimensional (3D) content or two-dimensional (2D) content may be used to determine the display context. The 3D content may include only two views as in a stereoscopic image or more that two views (e.g. four views) as in one or more of a horizontal parallax, vertical parallax or full parallax multiview image. As such, many considerations may be involved in determining display context and, in turn, selecting a lightfield display mode from among the lightfield display mode plurality.

In other embodiments, the lightfield mode selector 120 may comprise elements configured to monitor, a position of a head or hand of the user 101, a position of an eye of the user 101, and a position of an object held by the user 101 to determine display context. For simplicity of discussion herein, the terms ‘head’ and ‘hand’ of the user 101 is described with an understanding that the head or hand may represent any physical part or condition of the user 101 that may be monitored. In particular, the term ‘hand’ will be understood to at least include an entire hand as well as one or more digits of the hand, by definition herein. Further by definition herein, monitoring a ‘position’ includes, but is not limited to, monitoring a location and monitoring a relative motion. In yet other embodiments, the lightfield mode selector 120 is configured to receive an input from an application executed by the contextual lightfield display system 100, the display context being determined based on the input from the executed application.

As mentioned previously, the contextual lightfield display system 100 is configured to provide a plurality of lightfield display modes, each lightfield display mode having a mode-specific arrangement of views. Further, the contextual lightfield display system 100 is configured to provide a selected lightfield display mode using the lightfield mode selector 120 and a determined display context.

In some embodiments, the selected lightfield display mode may be a stereoscopic three-dimensional (3D) display mode of the contextual lightfield display system 100. In the stereoscopic 3D display mode, the mode-specific arrangement of the different views is configured to provide a stereoscopic representation of the multiview image. That is, the stereoscopic 3D display mode may provide image parallax corresponding to different left-eye and right-eye views of a stereoscopic image, for example.

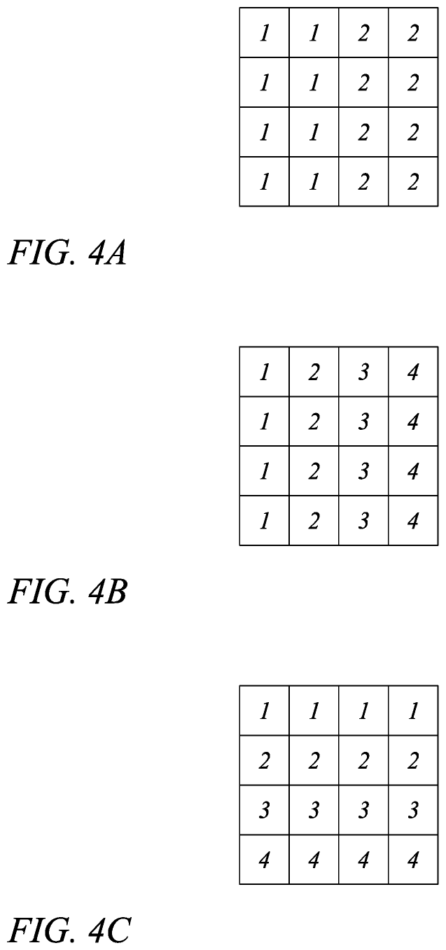

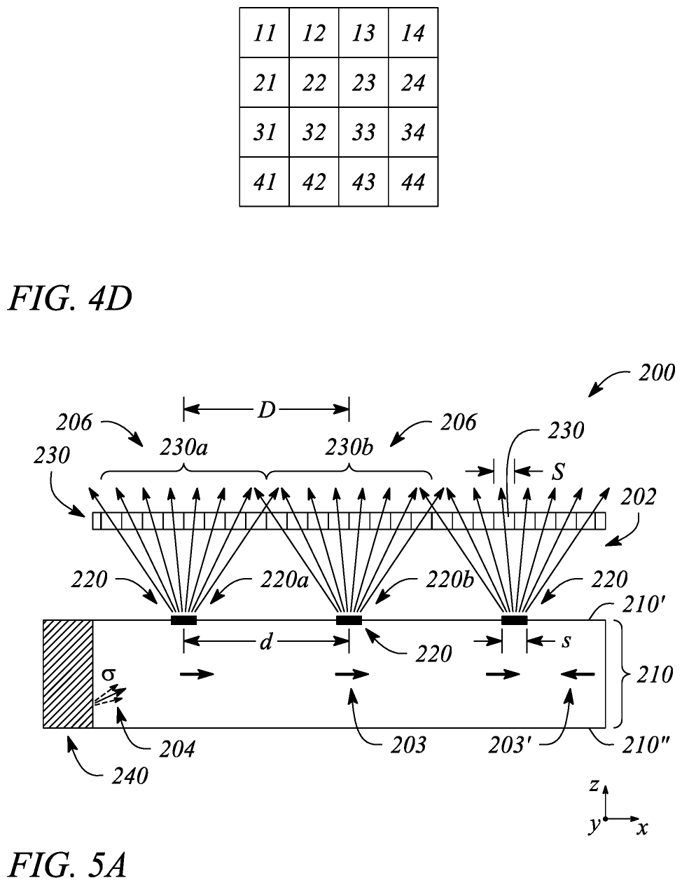

FIG. 4A illustrates a graphical representation of an arrangement of views of a multiview display 110 corresponding to a stereoscopic display mode in an example, according to an embodiment consistent with the principles described herein. In particular, As illustrated, the stereoscopic 3D display mode comprises a pair of views of which a first view ‘1’ corresponds to a left-eye′ view or perspective and second view ‘2’ corresponds to a ‘right-eye’ view or perspective of an image, object or scene. As illustrated, views of the pair of views are distributed across available views of the multiview display 110 such that the first view 1 is repeated in a set of available views exclusively located to a left of center on the multiview display 110. Likewise, the second view 2 is repeated in a set of available views exclusively located to a right of center on the multiview display 110, as illustrated. Together the repeated first views 1 to the left of center and the repeated second views 2 the right of center provide a stereoscopic multiview image to the user 101 viewing the multiview display 110 in the stereoscopic 3D display mode.

In some embodiments, the selected lightfield display mode may be a unidirectional parallax display mode of the contextual lightfield display system 100. In the unidirectional parallax display mode, the mode-specific arrangement the different views is configured to provide a unidirectional parallax representation of the multiview image. For example, the unidirectional parallax representation may be one of a horizontal parallax representation (e.g., landscape) and a vertical parallax representation (e.g., portrait).

FIG. 4B illustrates a graphical representation of an arrangement of views of a multiview display 110 corresponding to a unidirectional parallax display mode in an example, according to an embodiment consistent with the principles described herein. FIG. 4C illustrates a graphical representation of an arrangement of views of a multiview display 110 corresponding to a unidirectional parallax display mode in another example, according to an embodiment consistent with the principles described herein. In particular, FIG. 4B may represent a horizontal parallax (landscape) display mode and FIG. 4C may represent a vertical parallax (or portrait) display mode. As illustrated in both FIGS. 4B and 4C, a multiview image includes four different views, labeled ‘1’, ‘2’, ‘3’, and ‘4’, representing four different perspectives of an image, object or scene. In FIG. 4B, the four different views are arranged in a horizontal direction, but repeated in a vertical direction. As such, the user 101 viewing the multiview image in the horizontal parallax display mode of FIG. 4B may perceive horizontal parallax when rotating the multiview display 110 about a vertical axis, for example. Likewise, the user 101 viewing the multiview image in the vertical parallax display mode of FIG. 4C may perceive vertical parallax when rotating the multiview display 110 about a horizontal axis, for example.

In some embodiments, the selected lightfield mode may be a full parallax display mode. In the full parallax display mode, the mode-specific arrangement of the different views corresponds to a full parallax view arrangement configured to provide a full parallax representation of the multiview image. In particular, the parallax of the multiview image may be perceived by the user 101 regardless of a change in viewing angle (e.g., according to both horizontal and vertical rotations).

FIG. 4D illustrates a graphical representation of an arrangement of views of a multiview display 110 corresponding to a full parallax display mode in an example, according to an embodiment consistent with the principles described herein. In particular, a multiview image may include sixteen different views representing sixteen different perspectives of an image, object or scene, by way of example and not limitation. As illustrated, the sixteen different views may be arranged in across the multiview display 110 according to rows and columns, labeled ‘11’, ‘12’, ‘13’, ‘14’, ‘21’, ‘22’, and so on. That is, there are four different perspectives of the image, object, or scene represented by the full parallax display mode in each of the horizontal direction and the vertical direction. Accordingly, the user 101 viewing the multiview image on the multiview display 110 in the full parallax display mode of FIG. 4D may perceive vertical parallax when rotating the multiview display 110 about a horizontal axis and horizontal parallax when rotating the multiview display about a vertical axis, for example. Note that specific numbers of views (e.g., four, sixteen, etc.) described herein are provided for discussion purposes only and not by way of limitation.

In some embodiments (not explicitly illustrated in the block diagram of FIG. 3A), the contextual lightfield display system 100 may further comprise a processing subsystem, a memory subsystem, a power subsystem, and a networking subsystem. The processing subsystem may include one or more devices configured to perform computational operations such as, but not limited to, a microprocessor, a graphics processing unit (GPU) or a digital signal processor (DSP). The memory subsystem may include one or more devices for storing one or both of data and instructions that may be used by the processing subsystem to provide and control operation the contextual lightfield display system 100. For example, memory subsystem may include one or more types of memory including, but not limited to, random access memory (RAM), read-only memory (ROM), and various forms of flash memory. According to some embodiments, stored data and stored instructions may include, but are not limited to, data and instructions that, when executed by the processing subsystem, are configured to one or more to display the multiview content on the multiview display 110 as the multiview image, to process the multiview content or the multiview image(s) to be displayed, to control the multiview content in response to inputs including the location of the hand of the user 101 representing control gestures, and to provide the haptic feedback.

Further, the stored data and stored instructions within the memory subsystem, when executed by the processing subsystem, may be configured to implement either a portion or all of the lightfield mode selector 120, in some embodiments. For example, the stored data and stored instructions may be configured to receive an input from an orientation sensor of the lightfield mode selector 120 and determine the display context from a detected orientation, as outlined above. Further the stored data and stored instructions may select from among available lightfield display modes and provide direction to the multiview display 110 with respect to an appropriate mode-specific arrangement of different views, accordingly.

As described above, the lightfield mode selector 120 may be configured to receive an input from an application executed by the contextual lightfield display system 100 (e.g., the processor subsystem) and to determine the display context based on the input from the executed application. The executed application may be stored as one or both of instructions and data in the memory subsystem. Further, the portion of the lightfield mode selector 120 that receives the input from the application may also be stored as one or both of data and instructions in the memory subsystem, in some embodiments.

In some embodiments, instructions stored in the memory subsystem and used by the processing subsystem include, but are not limited to program instructions or sets of instructions and an operating system, for example. The program instructions and operating system may be executed by processing subsystem during operation of the contextual lightfield display system 100, for example. Note that the one or more computer programs may constitute a computer-program mechanism, a computer-readable storage medium or software. Moreover, instructions in the various modules in memory subsystem may be implemented in one or more of a high-level procedural language, an object-oriented programming language, and in an assembly or machine language. Furthermore, the programming language may be compiled or interpreted, e.g., configurable or configured (which may be used interchangeably in this discussion), to be executed by processing subsystem, according to various embodiments.

In various embodiments, the power subsystem may include one or more energy storage components (such as a battery) configured to provide power to other components in the contextual lightfield display system 100. The networking subsystem may include one or more devices and subsystem or modules configured to couple to and communicate on one or both of a wired and a wireless network (i.e., to perform network operations). For example, networking subsystem may include any or all of a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a WiFi networking system), an Ethernet networking system.

Note that, while some of the operations in the preceding embodiments may be implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the display technique may be implemented using program instructions, the operating system (such as a driver for display subsystem) or in hardware.

FIG. 5A illustrates a cross sectional view of a multiview display 200 in an example, according to an embodiment consistent with the principles described herein. FIG. 5B illustrates a plan view of a multiview display 200 in an example, according to an embodiment consistent with the principles described herein. FIG. 5C illustrates a perspective view of a multiview display 200 in an example, according to an embodiment consistent with the principles described herein. The perspective view in FIG. 5C is illustrated with a partial cut-away to facilitate discussion herein only. The multiview display 200 illustrated in FIGS. 5A-5C may be employed as the multiview display 110 of the contextual lightfield display system 100, according to some embodiments.

As illustrated in FIGS. 5A-5C, the multiview display 200 is configured to provide a plurality of directional light beams 202 having different principal angular directions from one another (e.g., as a lightfield). In particular, the provided plurality of directional light beams 202 may be scattered out and directed away from the multiview display 200 in different principal angular directions corresponding to respective view directions of a multiview display, according to various embodiments. In some embodiments, the directional light beams 202 may be modulated (e.g., using light valves, as described below) to facilitate the display of information having multiview content, e.g., a multiview image. FIGS. 5A-5C also illustrate a multiview pixel 206 comprising sub-pixels and an array of light valves 230, which are described in further detail below.

As illustrated in FIGS. 5A-5C, the multiview display 200 comprises a light guide 210. The light guide 210 is configured to guide light along a length of the light guide 210 as guided light 204 (i.e., a guided light beam). For example, the light guide 210 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 204 according to one or more guided modes of the light guide 210, for example.

In some embodiments, the light guide 210 may be a slab or plate optical waveguide (i.e., a plate light guide) comprising an extended, substantially planar sheet of optically transparent, dielectric material. The substantially planar sheet of dielectric material is configured to guide the guided light 204 using total internal reflection. According to various examples, the optically transparent material of the light guide 210 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 210 may further include a cladding layer (not illustrated) on at least a portion of a surface (e.g., one or both of the top surface and the bottom surface) of the light guide 210. The cladding layer may be used to further facilitate total internal reflection, according to some examples.

Further, according to some embodiments, the light guide 210 is configured to guide the guided light 204 (e.g., as a guided light beam) according to total internal reflection at a non-zero propagation angle between a first surface 210′ (e.g., ‘front’ surface or side) and a second surface 210″ (e.g., ‘back’ surface or side) of the light guide 210. In particular, the guided light 204 propagates by reflecting or ‘bouncing’ between the first surface 210′ and the second surface 210″ of the light guide 210 at the non-zero propagation angle. In some embodiments, the guided light 204 as a plurality of guided light beams comprising different colors of light may be guided by the light guide 210, each guided light beam being guided a at respective one of a plurality of different color-specific, non-zero propagation angles. The non-zero propagation angle is not illustrated in FIGS. 5A-5C for simplicity of illustration. However, a bold arrow depicts a propagation direction 203 of the guided light 204 along the light guide length in FIG. 5A.

As defined herein, a ‘non-zero propagation angle’ is an angle relative to a surface (e.g., the first surface 210′ or the second surface 210″) of the light guide 210. Further, the non-zero propagation angle is both greater than zero and less than a critical angle of total internal reflection within the light guide 210, according to various embodiments. For example, the non-zero propagation angle of the guided light 204 may be between about ten (10) degrees and about fifty (50) degrees or, in some examples, between about twenty (20) degrees and about forty (40) degrees, or between about twenty-five (25) degrees and about thirty-five (35) degrees. For example, the non-zero propagation angle may be about thirty (30) degrees. In other examples, the non-zero propagation angle may be about 20 degrees, or about 25 degrees, or about 35 degrees. Moreover, a specific non-zero propagation angle may be chosen (e.g., arbitrarily) for a particular implementation as long as the specific non-zero propagation angle is chosen to be less than the critical angle of total internal reflection within the light guide 210.

The guided light 204 in the light guide 210 may be introduced or coupled into the light guide 210 at the non-zero propagation angle (e.g., about 30-35 degrees). In some examples, a coupling structure such as, but not limited to, a lens, a mirror or similar reflector (e.g., a tilted collimating reflector), a diffraction grating, and a prism as well as various combinations thereof may facilitate coupling light into an input end of the light guide 210 as the guided light 204 at the non-zero propagation angle. In other examples, light may be introduced directly into the input end of the light guide 210 either without or substantially without the use of a coupling structure (i.e., direct or ‘butt’ coupling may be employed). Once coupled into the light guide 210, the guided light 204 is configured to propagate along the light guide 210 in a propagation direction 203 that may be generally away from the input end (e.g., illustrated by bold arrows pointing along an x-axis in FIG. 5A).

Further, the guided light 204, produced by coupling light into the light guide 210 may be a collimated light beam, according to various embodiments. Herein, a ‘collimated light’ or a ‘collimated light beam’ is generally defined as a beam of light in which rays of the light beam are substantially parallel to one another within the light beam (e.g., the guided light 204). Also by definition herein, rays of light that diverge or are scattered from the collimated light beam are not considered to be part of the collimated light beam. In some embodiments (not illustrated), the multiview display 200 may include a collimator, such as a lens, reflector or mirror, as described above, (e.g., tilted collimating reflector) to collimate the light, e.g., from a light source. In some embodiments, the light source itself comprises a collimator. The collimated light provided to the light guide 210 is a collimated guided light beam. The guided light 204 may be collimated according to or having a collimation factor σ, in some embodiments. Alternatively, the guided light 204 may be uncollimated, in other embodiments.

In some embodiments, the light guide 210 may be configured to ‘recycle’ the guided light 204. In particular, the guided light 204 that has been guided along the light guide length may be redirected back along that length in another propagation direction 203′ that differs from the propagation direction 203. For example, the light guide 210 may include a reflector (not illustrated) at an end of the light guide 210 opposite to an input end adjacent to the light source. The reflector may be configured to reflect the guided light 204 back toward the input end as recycled guided light. In some embodiments, another light source may provide guided light 204 in the other propagation direction 203′ instead of or in addition to light recycling (e.g., using a reflector). One or both of recycling the guided light 204 and using another light source to provide guided light 204 having the other propagation direction 203′ may increase a brightness of the multiview display 200 (e.g., increase an intensity of the directional light beams 202) by making guided light available more than once, for example, to multibeam elements, described below. In FIG. 5A, a bold arrow indicating a propagation direction 203′ of recycled guided light (e.g., directed in a negative x-direction) illustrates a general propagation direction of the recycled guided light within the light guide 210.

As illustrated in FIGS. 5A-5C, the multiview display 200 further comprises a plurality of multibeam elements 220 spaced apart from one another along the light guide length. In particular, the multibeam elements 220 of the plurality are separated from one another by a finite space and represent individual, distinct elements along the light guide length. That is, by definition herein, the multibeam elements 220 of the plurality are spaced apart from one another according to a finite (i.e., non-zero) inter-element distance (e.g., a finite center-to-center distance). Further, the multibeam elements 220 of the plurality generally do not intersect, overlap or otherwise touch one another, according to some embodiments. That is, each multibeam element 220 of the plurality is generally distinct and separated from other ones of the multibeam elements 220.

According to some embodiments, the multibeam elements 220 of the plurality may be arranged in either a one-dimensional (1D) array or a two-dimensional (2D) array. For example, the multibeam elements 220 may be arranged as a linear 1D array. In another example, the multibeam elements 220 may be arranged as a rectangular 2D array or as a circular 2D array. Further, the array (i.e., 1D or 2D array) may be a regular or uniform array, in some examples. In particular, an inter-element distance (e.g., center-to-center distance or spacing) between the multibeam elements 220 may be substantially uniform or constant across the array. In other examples, the inter-element distance between the multibeam elements 220 may be varied one or both of across the array and along the length of the light guide 210.

According to various embodiments, a multibeam element 220 of the multibeam element plurality is configured to provide, couple out or scatter out a portion of the guided light 204 as the plurality of directional light beams 202. For example, the guided light portion may be coupled out or scattered out using one or more of diffractive scattering, reflective scattering, and refractive scattering or coupling, according to various embodiments. FIGS. 5A and 5C illustrate the directional light beams 202 as a plurality of diverging arrows depicted directed way from the first (or front) surface 210′ of the light guide 210. Further, according to various embodiments, a size of the multibeam element 220 is comparable to a size of a sub-pixel (or equivalently a size of a light valve 230) of a multiview pixel 206, as illustrated in FIGS. 5A-5C. Herein, the ‘size’ may be defined in any of a variety of manners to include, but not be limited to, a length, a width or an area. For example, the size of a sub-pixel or a light valve 230 may be a length thereof and the comparable size of the multibeam element 220 may also be a length of the multibeam element 220. In another example, the size may refer to an area such that an area of the multibeam element 220 may be comparable to an area of the sub-pixel or the light value 230.

In some embodiments, the size of the multibeam element 220 is comparable to the sub-pixel size such that the multibeam element size is between about fifty percent (50%) and about two hundred percent (200%) of the sub-pixel size. For example, if the multibeam element size is denoted ‘s’ and the sub-pixel size is denoted ‘S’ (e.g., as illustrated in FIG. 5A), then the multibeam element size s may be given by

½S≤s≤2S

In other examples, the multibeam element size is in a range that is greater than about sixty percent (60%) of the sub-pixel size, or greater than about seventy percent (70%) of the sub-pixel size, or greater than about eighty percent (80%) of the sub-pixel size, or greater than about ninety percent (90%) of the sub-pixel size, and that is less than about one hundred eighty percent (180%) of the sub-pixel size, or less than about one hundred sixty percent (160%) of the sub-pixel size, or less than about one hundred forty (140%) of the sub-pixel size, or less than about one hundred twenty percent (120%) of the sub-pixel size. For example, by ‘comparable size’, the multibeam element size may be between about seventy-five percent (75%) and about one hundred fifty (150%) of the sub-pixel size. In another example, the multibeam element 220 may be comparable in size to the sub-pixel where the multibeam element size is between about one hundred twenty-five percent (125%) and about eighty-five percent (85%) of the sub-pixel size. According to some embodiments, the comparable sizes of the multibeam element 220 and the sub-pixel may be chosen to reduce, or in some examples to minimize, dark zones between views of the multiview display. Moreover, the comparable sizes of the multibeam element 220 and the sub-pixel may be chosen to reduce, and in some examples to minimize, an overlap between views (or view pixels) of the multiview display 200.

The multiview display 200 illustrated in FIGS. 5A-5C further comprises the array of light valves 230 configured to modulate the directional light beams 202 of the directional light beam plurality. As illustrated in FIGS. 5A-5C, different ones of the directional light beams 202 having different principal angular directions pass through and may be modulated by different ones of the light valves 230 in the light valve array. Further, as illustrated, a light valve 230 of the array corresponds to a sub-pixel of the multiview pixel 206, and a set of the light valves 230 corresponds to a multiview pixel 206 of the multiview display. In particular, a different set of light valves 230 of the light valve array is configured to receive and modulate the directional light beams 202 from a corresponding one of the multibeam elements 220, i.e., there is one unique set of light valves 230 for each multibeam element 220, as illustrated. In various embodiments, different types of light valves may be employed as the light valves 230 of the light valve array including, but not limited to, one or more of liquid crystal light valves, electrophoretic light valves, and light valves based on electrowetting.

As illustrated in FIG. 5A, a first light valve set 230a is configured to receive and modulate the directional light beams 202 from a first multibeam element 220a. Further, a second light valve set 230b is configured to receive and modulate the directional light beams 202 from a second multibeam element 220b. Thus, each of the light valve sets (e.g., the first and second light valve sets 230a, 230b) in the light valve array corresponds, respectively, both to a different multibeam element 220 (e.g., elements 220a, 220b) and to a different multiview pixel 206, with individual light valves 230 of the light valve sets corresponding to the sub-pixels of the respective multiview pixels 206, as illustrated in FIG. 5A.

In some embodiments, a relationship between the multibeam elements 220 and corresponding multiview pixels 206 (i.e., sets of sub-pixels and corresponding sets of light valves 230) may be a one-to-one relationship. That is, there may be an equal number of multiview pixels 206 and multibeam elements 220. FIG. 5B explicitly illustrates by way of example the one-to-one relationship where each multiview pixel 206 comprising a different set of light valves 230 (and corresponding sub-pixels) is illustrated as surrounded by a dashed line. In other embodiments (not illustrated), a number of multiview pixels 206 and a number of multibeam elements 220 may differ from one another.

In some embodiments, an inter-element distance (e.g., center-to-center distance) between a pair of multibeam elements 220 of the plurality may be equal to an inter-pixel distance (e.g., a center-to-center distance) between a corresponding pair of multiview pixels 206, e.g., represented by light valve sets. For example, as illustrated in FIG. 5A, a center-to-center distance d between the first multibeam element 220a and the second multibeam element 220b is substantially equal to a center-to-center distance D between the first light valve set 230a and the second light valve set 230b. In other embodiments (not illustrated), the relative center-to-center distances of pairs of multibeam elements 220 and corresponding light valve sets may differ, e.g., the multibeam elements 220 may have an inter-element spacing (i.e., center-to-center distance d) that is one of greater than or less than a spacing (i.e., center-to-center distance D) between light valve sets representing multiview pixels 206.

In some embodiments, a shape of the multibeam element 220 is analogous to a shape of the multiview pixel 206 or equivalently, to a shape of a set (or ‘sub-array’) of the light valves 230 corresponding to the multiview pixel 206. For example, the multibeam element 220 may have a square shape and the multiview pixel 206 (or an arrangement of a corresponding set of light valves 230) may be substantially square. In another example, the multibeam element 220 may have a rectangular shape, i.e., may have a length or longitudinal dimension that is greater than a width or transverse dimension. In this example, the multiview pixel 206 (or equivalently the arrangement of the set of light valves 230) corresponding to the multibeam element 220 may have an analogous rectangular shape. FIG. 5B illustrates a top or plan view of square-shaped multibeam elements 220 and corresponding square-shaped multiview pixels 206 comprising square sets of light valves 230. In yet other examples (not illustrated), the multibeam elements 220 and the corresponding multiview pixels 206 have various shapes including or at least approximated by, but not limited to, a triangular shape, a hexagonal shape, and a circular shape. Therefore, in these embodiments, there may not, in general, be a relationship between the shape of the multibeam element 220 and the shape of the multiview pixel 206.

Further (e.g., as illustrated in FIG. 5A), each multibeam element 220 is configured to provide directional light beams 202 to one and only one multiview pixel 206 at a given time based on the set of sub-pixels that are currently assigned to a particular multiview pixel 206, according to some embodiments. In particular, for a given one of the multibeam elements 220 and a current assignment of the set of sub-pixels to a particular multiview pixel 206, the directional light beams 202 having different principal angular directions corresponding to the different views of the multiview display are substantially confined to the single corresponding multiview pixel 206 and the sub-pixels thereof, i.e., a single set of light valves 230 corresponding to the multibeam element 220, as illustrated in FIG. 5A. As such, each multibeam element 220 of the multiview display 200 provides a corresponding set of directional light beams 202 that has a set of the different principal angular directions corresponding to the current different views of the multiview display (i.e., the set of directional light beams 202 contains a light beam having a direction corresponding to each of the current different view directions).

Referring again to FIG. 5A, the multiview display 200 further comprises a light source 240. According to various embodiments, the light source 240 is configured to provide the light to be guided within light guide 210. In particular, the light source 240 may be located adjacent to an entrance surface or end (input end) of the light guide 210. In various embodiments, the light source 240 may comprise substantially any source of light (e.g., optical emitter) including, but not limited to, an LED, a laser (e.g., laser diode) or a combination thereof. In some embodiments, the light source 240 may comprise an optical emitter configured produce a substantially monochromatic light having a narrowband spectrum denoted by a particular color. In particular, the color of the monochromatic light may be a primary color of a particular color space or color model (e.g., a red-green-blue (RGB) color model). In other examples, the light source 240 may be a substantially broadband light source configured to provide substantially broadband or polychromatic light. For example, the light source 240 may provide white light. In some embodiments, the light source 240 may comprise a plurality of different optical emitters configured to provide different colors of light. The different optical emitters may be configured to provide light having different, color-specific, non-zero propagation angles of the guided light corresponding to each of the different colors of light.

In some embodiments, the light source 240 may further comprise a collimator. The collimator may be configured to receive substantially uncollimated light from one or more of the optical emitters of the light source 240. The collimator is further configured to convert the substantially uncollimated light into collimated light. In particular, the collimator may provide collimated light having the non-zero propagation angle and being collimated according to a predetermined collimation factor, according to some embodiments. Moreover, when optical emitters of different colors are employed, the collimator may be configured to provide the collimated light having one or both of different, color-specific, non-zero propagation angles and having different color-specific collimation factors. The collimator is further configured to communicate the collimated light beam to the light guide 210 to propagate as the guided light 204, described above.

In some embodiments, the multiview display 200 is configured to be substantially transparent to light in a direction through the light guide 210 orthogonal to (or substantially orthogonal) to a propagation direction 203, 203′ of the guided light 204. In particular, the light guide 210 and the spaced apart multibeam elements 220 allow light to pass through the light guide 210 through both the first surface 210′ and the second surface 210″, in some embodiments. Transparency may be facilitated, at least in part, due to both the relatively small size of the multibeam elements 220 and the relative large inter-element spacing (e.g., one-to-one correspondence with the multiview pixels 206) of the multibeam element 220. Further, the multibeam elements 220 may also be substantially transparent to light propagating orthogonal to the light guide surfaces 210′, 210″, according to some embodiments.

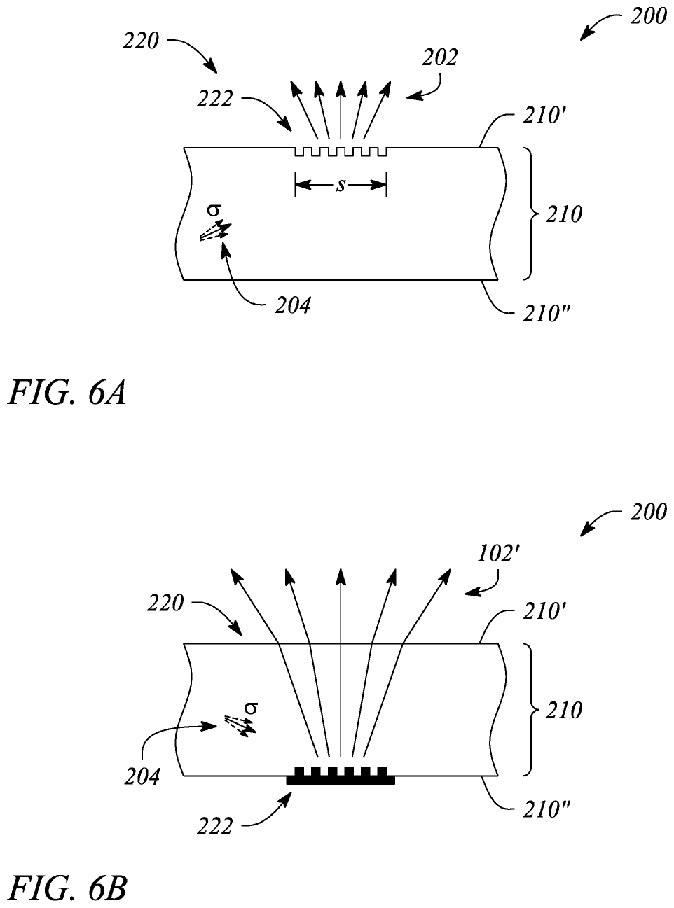

FIG. 6A illustrates a cross sectional view of a portion of a multiview display 200 including a multibeam element 220 in an example, according to an embodiment consistent with the principles described herein. FIG. 6B illustrates a cross sectional view of a portion of a multiview display 200 including a multibeam element 220 in an example, according to another embodiment consistent with the principles described herein. In particular, FIGS. 6A-6B illustrate the multibeam element 220 comprising a diffraction grating 222. The diffraction grating 222 is configured to diffractively scatter out a portion of the guided light 204 as the plurality of directional light beams 202. The diffraction grating 222 comprises a plurality of diffractive features spaced apart from one another by a diffractive feature spacing or a diffractive feature or grating pitch configured to provide diffractive coupling out of the guided light portion. According to various embodiments, the spacing or grating pitch of the diffractive features in the diffraction grating 222 may be sub-wavelength (i.e., less than a wavelength of the guided light).

In some embodiments, the diffraction grating 222 of the multibeam element 220 may be located at or adjacent to a surface of the light guide 210 of the multiview display 200. For example, the diffraction grating 222 may be at or adjacent to the first surface 210′ of the light guide 210, as illustrated in FIG. 6A. The diffraction grating 222 at light guide first surface 210′ may be a transmission mode diffraction grating configured to diffractively scatter out the guided light portion through the first surface 210′ as the directional light beams 202. In another example, as illustrated in FIG. 6B, the diffraction grating 222 may be located at or adjacent to the second surface 210″ of the light guide 210. When located at the second surface 210″, the diffraction grating 222 may be a reflection mode diffraction grating. As a reflection mode diffraction grating, the diffraction grating 222 is configured to both diffract the guided light portion and reflect the diffracted guided light portion toward the first surface 210′ to exit through the first surface 210′ as the diffractively directional light beams 202. In other embodiments (not illustrated), the diffraction grating may be located between the surfaces of the light guide 210, e.g., as one or both of a transmission mode diffraction grating and a reflection mode diffraction grating.

According to some embodiments, the diffractive features of the diffraction grating 222 may comprise one or both of grooves and ridges that are spaced apart from one another. The grooves or the ridges may comprise a material of the light guide 210, e.g., may be formed in a surface of the light guide 210. In another example, the grooves or the ridges may be formed from a material other than the light guide material, e.g., a film or a layer of another material on a surface of the light guide 210.

In some embodiments, the diffraction grating 222 of the multibeam element 220 is a uniform diffraction grating in which the diffractive feature spacing is substantially constant or unvarying throughout the diffraction grating 222. In other embodiments, the diffraction grating 222 is a chirped diffraction grating. By definition, the ‘chirped’ diffraction grating is a diffraction grating exhibiting or having a diffraction spacing of the diffractive features (i.e., the grating pitch) that varies across an extent or length of the chirped diffraction grating. In some embodiments, the chirped diffraction grating may have or exhibit a chirp of the diffractive feature spacing that varies linearly with distance. As such, the chirped diffraction grating is a ‘linearly chirped’ diffraction grating, by definition. In other embodiments, the chirped diffraction grating of the multibeam element 220 may exhibit a non-linear chirp of the diffractive feature spacing. Various non-linear chirps may be used including, but not limited to, an exponential chirp, a logarithmic chirp or a chirp that varies in another, substantially non-uniform or random but still monotonic manner. Non-monotonic chirps such as, but not limited to, a sinusoidal chirp or a triangle or sawtooth chirp, may also be employed. Combinations of any of these types of chirps may also be employed.

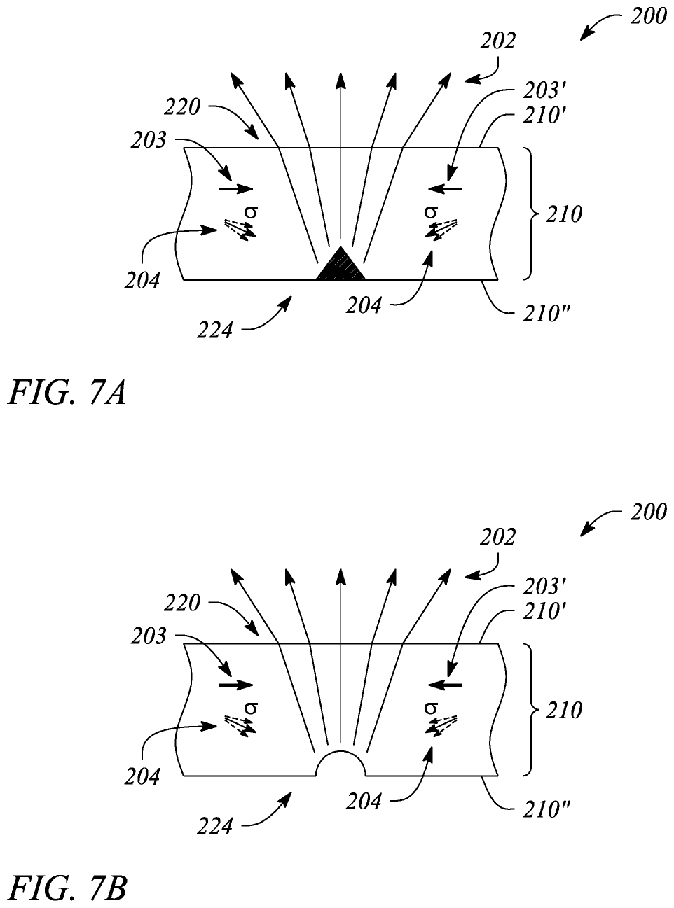

FIG. 7A illustrates a cross sectional view of a portion of a multiview display 200 including a multibeam element 220 in an example, according to another embodiment consistent with the principles described herein. FIG. 7B illustrates a cross sectional view of a portion of a multiview display 200 including a multibeam element 220 in an example, according to another embodiment consistent with the principles described herein. In particular, FIGS. 7A and 7B illustrate various embodiments of the multibeam element 220 comprising a micro-reflective element. Micro-reflective elements used as or in the multibeam element 220 may include, but are not limited to, a reflector that employs a reflective material or layer thereof (e.g., a reflective metal) or a reflector based on total internal reflection (TIR). According to some embodiments (e.g., as illustrated in FIGS. 7A-7B), the multibeam element 220 comprising the micro-reflective element may be located at or adjacent to a surface (e.g., the second surface 210″) of the light guide 210. In other embodiments (not illustrated), the micro-reflective element may be located within the light guide 210 between the first and second surfaces 210′, 210″.

For example, FIG. 7A illustrates the multibeam element 220 comprising a micro-reflective element 224 having reflective facets (e.g., a ‘prismatic’ micro-reflective element) located adjacent to the second surface 210″ of the light guide 210. The facets of the illustrated prismatic micro-reflective element 224 are configured to reflect (i.e., reflectively couple) the portion of the guided light 204 out of the light guide 210. The facets may be slanted or tilted (i.e., have a tilt angle) relative to a propagation direction of the guided light 204 to reflect the guided light portion out of light guide 210, for example. The facets may be formed using a reflective material within the light guide 210 (e.g., as illustrated in FIG. 7A) or may be surfaces of a prismatic cavity in the second surface 210″, according to various embodiments. When a prismatic cavity is employed, either a refractive index change at the cavity surfaces may provide reflection (e.g., TIR reflection) or the cavity surfaces that form the facets may be coated by a reflective material to provide reflection, in some embodiments.

In another example, FIG. 7B illustrates the multibeam element 220 comprising a micro-reflective element 224 having a substantially smooth, curved surface such as, but not limited to, a semi-spherical micro-reflective element 224. A specific surface curve of the micro-reflective element 224 may be configured to reflect the guided light portion in different directions depending on a point of incidence on the curved surface with which the guided light 204 makes contact, for example. As illustrated in FIGS. 7A and 7B, the guided light portion that is reflectively scattered out of the light guide 210 exits or is emitted from the first surface 210′, by way of example and not limitation. As with the prismatic micro-reflective element 224 in FIG. 7A, the micro-reflective element 224 in FIG. 7B may be either a reflective material within the light guide 210 or a cavity (e.g., a semi-circular cavity) formed in the second surface 210″, as illustrated in FIG. 7B by way of example and not limitation. FIGS. 7A and 7B also illustrate the guided light 204 having two propagation directions 203, 203′ (i.e., illustrated as bold arrows), by way of example and not limitation. Using two propagation directions 203, 203′ may facilitate providing the plurality of directional light beams 202 with symmetrical principal angular directions, for example.

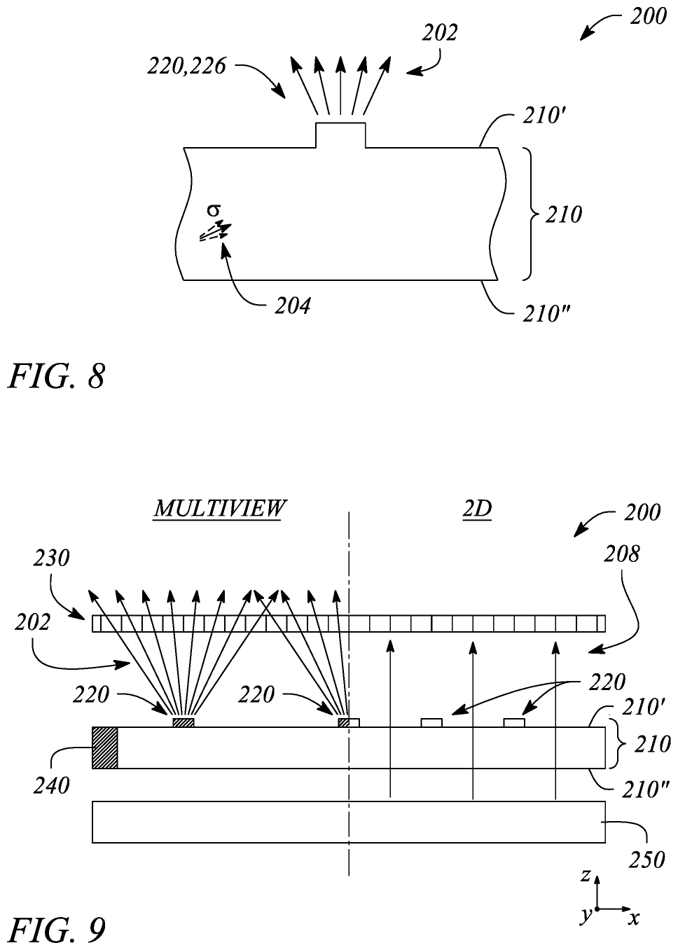

FIG. 8 illustrates a cross sectional view of a portion of a multiview display 200 including a multibeam element 220 in an example, according to another embodiment consistent with the principles described herein. In particular, FIG. 8 illustrates a multibeam element 220 comprising a micro-refractive element 226. According to various embodiments, the micro-refractive element 226 is configured to refractively couple out a portion of the guided light 204 from the light guide 210. That is, the micro-refractive element 226 is configured to employ refraction (e.g., as opposed to diffraction or reflection) to couple or scatter out the guided light portion from the light guide 210 as the directional light beams 202, as illustrated in FIG. 8. The micro-refractive element 226 may have various shapes including, but not limited to, a semi-spherical shape, a rectangular shape or a prismatic shape (i.e., a shape having sloped facets). According to various embodiments, the micro-refractive element 226 may extend or protrude out of a surface (e.g., the first surface 210′) of the light guide 210, as illustrated, or may be a cavity in the surface (not illustrated). Further, the micro-refractive element 226 may comprise a material of the light guide 210, in some embodiments. In other embodiments, the micro-refractive element 226 may comprise another material adjacent to, and in some examples, in contact with the light guide surface.

According to some embodiments, the contextual lightfield display system 100 further comprises a two-dimensional (2D) display configured to display a 2D image. In these embodiments, the lightfield display mode selected by the lightfield mode selector is a 2D display mode configured to display a single broad-angle view of the 2D image. A determined display context corresponding to selecting the 2D display mode may detection of 2D context with an image file to be displayed. In particular, according to some embodiments, the multiview display 200 (e.g., representing an embodiment of the multiview display 110 of the contextual lightfield display system 100) may further comprise a broad-angle backlight adjacent to the light guide 210. The broad-angle backlight may be used to facilitate displaying the 2D image in the 2D display mode, for example.

FIG. 9 illustrates a cross-sectional view of a multiview display 200 in an example, according to another embodiment consistent with the principles described herein. As illustrated in FIG. 9, the multiview display 200 comprises the light guide 210, the plurality of multibeam elements 220, the array of light valves 230, and the light source 240, as described above. Together, the light guide 210, the multibeam element 220, and the light source 240 may serve as a multibeam backlight configured to emit the plurality of directional light beams 202. The illustrated multiview display 200 of FIG. 9 further comprises a broad-angle backlight 250. The broad-angle backlight 250 is located on a side of the multibeam backlight opposite to the side adjacent to the light valve array. In particular, the broad-angle backlight 250 is adjacent to the second surface 210″ of the light guide 210 opposite to the first surface 210′, as illustrated. The broad-angle backlight 250 is configured to provide broad-angle emitted light 208 during the 2D display mode, according to various embodiments.

As illustrated in FIG. 9, the multibeam backlight of the multiview display 200 is configured to be optically transparent to the broad-angle emitted light 208 emitted from the broad-angle backlight 250. In particular, at least the light guide 210 together with the plurality of multibeam elements 220 of the multibeam backlight are configured to be optically transparent to the broad-angle emitted light 208 propagating in a direction that is generally from the second surface 210″ to the first surface 210′ of the light guide 210. Thus, the broad-angle emitted light 208 may be emitted from the broad-angle backlight 250 and then pass through a thickness of the multibeam backlight (or equivalent through a thickness of the light guide 210). The broad-angle emitted light 208 from the broad-angle backlight 250 may therefore be received through the second surface 210″ of the light guide 210, transmitted through a thickness of the light guide 210, and then emitted from a first surface 210′ of the light guide 210. Since the multibeam backlight is configured to be optically transparent to the broad-angle emitted light 208, the broad-angle emitted light 208 is not substantially affected by the multibeam backlight, according to some embodiments.

According to various embodiments, the multiview display 200 of FIG. 9 may selectively operate in the 2D display mode or one or more of the multiview lightfield display modes (Multiview), as described above. In the 2D display mode, the multiview display 200 is configured to emit the broad-angle emitted light 208 provided by the broad-angle backlight 250. In turn, the broad-angle emitted light 208 may be modulated by the light valves 230 to provide a 2D image during the 2D display mode. As such, lightfield mode selector 120 of the contextual lightfield display system 100 may selectively employ the broad-angle backlight 250 of the multiview display 200 of FIG. 9 to display the 2D image during a 2D display mode, as determined by the display context. Alternatively, when the display context dictates a multiview image is to be displayed, the lightfield mode selector 120 may employ the multibeam backlight of the multiview display 200 in FIG. 9 to emit the directional light beams 202, which may then be modulated by the light valves 230 to provide a multiview image according to a selected multiview lightfield display mode.

In accordance with some embodiments of the principles described herein, a contextual lightfield multiview display is provided. The contextual lightfield multiview display is configured display an image (e.g., a multiview image) according to a plurality of lightfield display modes. In particular, the lightfield display mode plurality may include, but is not limited to, a two-dimensional (2D) display mode configured to display 2D image content, a stereoscopic three-dimensional (3D) display mode configured to display stereoscopic 3D image content, a unidirectional parallax lightfield display mode, a full parallax display mode.

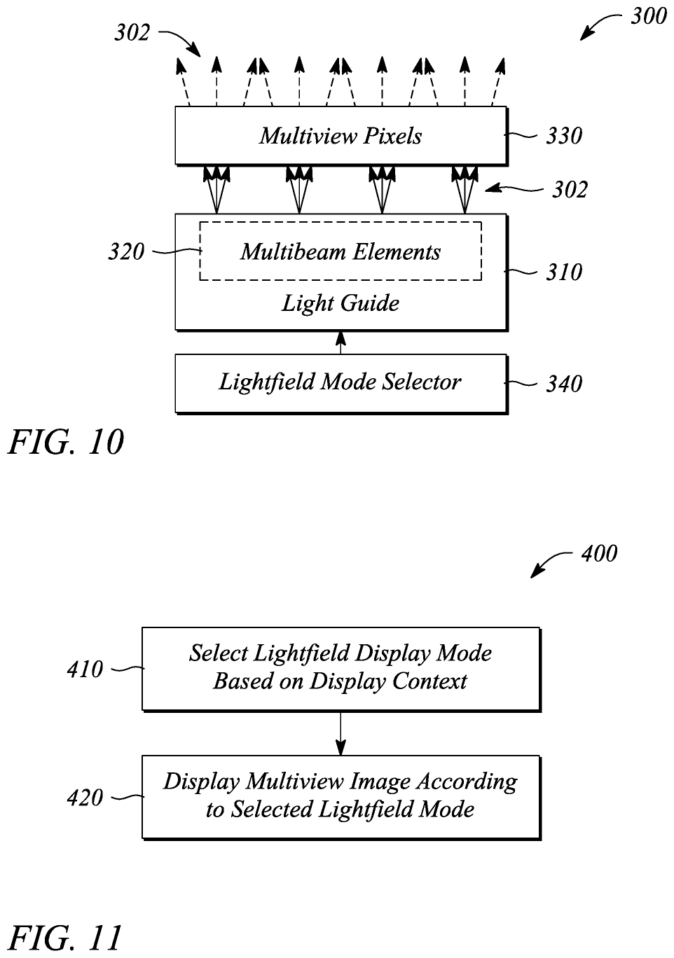

FIG. 10 illustrates a block diagram of a contextual lightfield multiview display 300 in an example, according to an embodiment of the principles described herein. As illustrated, the contextual lightfield multiview display 300 comprises a light guide 310. The light guide 310 is configured to guide light as guided light. In some embodiments, the light guide 310 may be substantially similar to the light guide 210 described above with respect to the multiview display 200.

The contextual lightfield multiview display 300 illustrated in FIG. 10 further comprises an array of multibeam element 320. Multibeam elements 320 of the multibeam element array are configured to scatter out a portion of the guided light as directional light beams 302 having directions corresponding to different views of a multiview image. In some embodiments, the multibeam elements 320 of the multibeam element array may be substantially similar to the multibeam elements 220 of the above-described multiview display 200. For example, the multibeam elements 320 may comprise one or more of a diffraction grating, a micro-reflective element, and a micro-refractive element, as described above.

As illustrated in FIG. 10, the contextual lightfield multiview display 300 further comprises an array of light valves 330. The array of light valves 330 is configured to modulate the directional light beams to provide the multiview image. According to various embodiments, different views of the multiview image are arranged in a rectangular array according to a lightfield display mode of the plurality of lightfield display modes. In some embodiments, the array of light valves 330 may be substantially similar to the array of light valves 230 of the multiview display 200, described above. Further, a size of a multibeam element 320 of the multibeam element array may be between one half of a size of a light valve 230 of the light valve array and two times the light valve size, in some embodiments.

According to various embodiments, the contextual lightfield multiview display 300 of FIG. 10 further comprises a lightfield mode selector 340. The lightfield mode selector 340 may be substantially similar to the lightfield mode selector 120 described above with respect to the contextual lightfield display system 100. In particular, the lightfield mode selector 340 is configured to select the lightfield display mode from among the lightfield display mode plurality based on a determined display context. Further, the multiview image is configured to be displayed by the contextual lightfield multiview display 300 according to the selected lightfield display mode, according to various embodiments.

In some embodiments, the selected lightfield display mode may be a stereoscopic three-dimensional (3D) display mode configured to represent the multiview image as a stereoscopic pair of images. In the stereoscopic 3D display mode, different views within a first half of the rectangular array of different views within the multiview image are configured to represent a first image of the stereoscopic image pair, while different views within a second half of the rectangular array of different views are configured to represent a second image of the stereoscopic image pair, according to various embodiments. In some embodiments, the selected lightfield display mode may be one of a unidirectional parallax display mode and a full parallax display mode.

In some embodiments, the lightfield mode selector 340 comprises an orientation sensor configured to detect an orientation of the contextual lightfield multiview display. In these embodiments, the display context may be determined from a detected orientation of the contextual lightfield multiview display. In some embodiments, the lightfield mode selector 340 is configured to determine the display context and select the lightfield display mode based on one or both of a content of the multiview image and an input from an application employs the contextual lightfield multiview display.

In some embodiments (not illustrated), the contextual lightfield multiview display 300 further comprises a broad-angle backlight. In particular, the broad-angle backlight may be located adjacent to a side of the light guide 310 opposite to a side of the light guide 310 adjacent to the light valve array. In various embodiments, the broad-angle backlight is configured to provide broad-angle emitted light during a two-dimensional (2D) lightfield mode of the contextual lightfield multiview display 300. Further, the light guide 310 and multibeam element array may be configured to be transparent to the broad-angle emitted light, in these embodiments. In addition, the contextual lightfield multiview display 300 is configured to display a 2D image during the 2D lightfield mode, according to various embodiments.

In accordance with other embodiments of the principles described herein, a method of contextual lightfield display system operation is provided. FIG. 11 illustrates a flow chart of a method 400 of contextual lightfield display system operation in an example, according to an embodiment consistent with the principles described herein. As illustrated in FIG. 11, the method 400 of contextual lightfield display system operation comprises selecting 410 a lightfield display mode from among a plurality of plurality of lightfield display modes according to or based on a determined display context using a lightfield mode selector. In some embodiments, the lightfield mode selector may be substantially similar to the lightfield mode selector 120 of the above-described contextual lightfield display system 100. Further, the selected lightfield display mode may comprise, but is not limited to, one of a stereoscopic three-dimensional (3D) display mode, a unidirectional parallax display mode, and a full parallax display mode, according to some embodiments. Moreover, the select lightfield display mode of the lightfield display mode plurality comprises a mode-specific rectangular arrangement of different views of the multiview image, according to various embodiments.

The method 400 of contextual lightfield display system operation further comprises displaying 420 a multiview image according to the selected lightfield display mode using a multiview display. In particular, displaying 420 the multiview image employs a multiview display configured to provide the plurality of lightfield display modes. In some embodiments, the multiview display used in displaying 420 a multiview image may be substantially similar to the multiview display 110 described above with respect to the contextual lightfield display system 100.

In some embodiments (not illustrated), method 400 of contextual lightfield display system operation further comprises displaying a two-dimensional (2D) image using the multiview display configured as a 2D display. The 2D image may be displayed when the lightfield display mode is determined to be a 2D display mode according to the determined display context, for example. The multiview display configured as a 2D display may include employing a broad-angle backlight that is substantially similar to the broad-angle backlight 250, as described above with respect to the multiview display 200.

Thus, there have been described examples and embodiments of a contextual lightfield display system, a contextual lightfield multiview display, and a method of contextual lightfield display system operation that provide selection among a plurality of lightfield display modes according to a determined display context. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A contextual lightfield display system comprising:
a multiview display configured to provide a plurality of lightfield display modes and to display a multiview image according to a selected lightfield display mode of the lightfield display modes; and
a lightfield mode selector configured to determine a display context and to select a lightfield display mode from among the plurality of lightfield display modes to be the selected lightfield display mode based on the determined display context,
wherein a lightfield display mode of the lightfield display mode plurality comprises a mode-specific arrangement of different views of the multiview image.

2. The contextual lightfield display system of claim 1, wherein the selected lightfield display mode is a stereoscopic three-dimensional (3D) display mode of the contextual lightfield display system, the mode-specific arrangement of the different views being configured to provide a stereoscopic representation of the multiview image.

3. The contextual lightfield display system of claim 1, wherein the selected lightfield display mode is a unidirectional parallax display mode of the contextual lightfield display system, the mode-specific arrangement of the different views being configured to provide a unidirectional parallax representation of the multiview image.

4. The contextual lightfield display system of claim 1, wherein the selected lightfield display mode is a full parallax display mode of the contextual lightfield display system, the mode-specific arrangement of the different views corresponding to a full parallax view arrangement configured to provide a full parallax representation of the multiview image.

5. The contextual lightfield display system of claim 1, wherein the multiview display comprises:
a light guide configured to guide light in a propagation direction along a length of the light guide as guided light; and
a plurality of multibeam elements distributed along the length of the light guide, a multibeam element of the multibeam element plurality being configured to scatter out from the light guide a portion of the guided light as a plurality of directional light beams having principal angular directions corresponding to the different views.

6. The contextual lightfield display system of claim 5, wherein the multiview display comprises an array of light valves configured to modulate directional light beams of the directional light beam plurality to provide the different views, a size of the multibeam element being between one half of a size of a light valve of the light valve array and two times the light valve size.

7. The contextual lightfield display system of claim 1, further comprising a two-dimensional (2D) display configured to display a 2D image, the lightfield display mode selected by the lightfield mode selector being a 2D display mode configured to display a single broad-angle view of the 2D image.

8. The contextual lightfield display system of claim 1, wherein the lightfield mode selector comprises an orientation sensor configured to detect an orientation of the multiview display, the display context being determined from a detected orientation of the multiview display.

9. The contextual lightfield display system of claim 8, wherein the orientation sensor comprises one or both of a gyroscope and an accelerometer.

10. The contextual lightfield display system of claim 1, wherein the lightfield mode selector is configured to receive an input from an application executed by the contextual lightfield display system, the display context being determined based on the input from the executed application.

11. The contextual lightfield display system of claim 1, wherein the lightfield mode selector is configured to determine the display context and select the lightfield display mode based on a content of the image.

12. A contextual lightfield multiview display comprising:
a light guide configured to guide light as guided light;
an array of multibeam elements configured to scatter out a portion of the guided light as directional light beams having the directions corresponding to different views of a multiview image;
an array of light valves configured to modulate the directional light beams to provide the multiview image, different views of the multiview image being arranged in a rectangular array according to a lightfield display mode of a plurality of lightfield display modes; and
a lightfield mode selector configured to select the lightfield display mode from among the lightfield display mode plurality based on a determined display context, the multiview image being displayed according to the selected lightfield display mode.

13. The contextual lightfield multiview display of claim 12, wherein the selected lightfield display mode is a stereoscopic three-dimensional (3D) display mode configured to represent the multiview image as a stereoscopic pair of images, different views within a first half of the rectangular array being configured to represent a first image of the stereoscopic image pair and different views within a second half of the rectangular array being configured to represent a second image of the stereoscopic image pair.

14. The contextual lightfield multiview display of claim 12, wherein the selected lightfield display mode is one of a unidirectional parallax display mode and a full parallax display mode.

15. The contextual lightfield multiview display of claim 12, wherein the lightfield mode selector comprises an orientation sensor configured to detect an orientation of the contextual lightfield multiview display, the display context being determined from a detected orientation of the contextual lightfield multiview display.

16. The contextual lightfield multiview display of claim 12, wherein the lightfield mode selector is configured to determine the display context and select the lightfield display mode based on one or both of a content of the multiview image and an input from an application employs the contextual lightfield multiview display.

17. The contextual lightfield multiview display of claim 12, further comprising a broad-angle backlight adjacent to a side of the light guide opposite to a side of the light guide adjacent to the light valve array, the broad-angle backlight being configured to provide broad-angle emitted light during a two-dimensional (2D) lightfield mode of the contextual lightfield multiview display, wherein the light guide and multibeam element array are configured to be transparent to the broad-angle emitted light, the contextual lightfield multiview display being configured to display a 2D image during the 2D lightfield mode.

18. A method of contextual lightfield display system operation, the method comprising:
selecting a lightfield display mode from among a plurality of plurality of lightfield display modes based on a determined display context using a lightfield mode selector; and
displaying a multiview image according to the selected lightfield display mode using a multiview display configured to provide the plurality of lightfield display modes,
wherein the selected lightfield display mode of the lightfield display mode plurality comprises a mode-specific rectangular arrangement of different views of the multiview image.

19. The method of contextual lightfield display system operation of claim 18, wherein the selected lightfield display mode comprises one of a stereoscopic three-dimensional (3D) display mode, a unidirectional parallax display mode, and a full parallax display mode.

20. The method of contextual lightfield display system operation of claim 18, further comprising displaying a two-dimensional (2D) image using the multiview display configured as a 2D display when the lightfield display mode is determined to be a 2D display mode according to the determined display context.
